(19) United States
(12) Patent Application Publication
(10) Pub. No.: US 2005/0282114 A1
(43) Pub. Date: Dec. 22, 2005

(54) Tooth separator/muscle relaxer

(76) Inventor: Emad El Haje, Washington, DC (US)

Correspondence Address: Barnes & Thornburg, Suite 900, 750 17th Street, NW, Washington, DC, 20006, US

(21) Appl. No.: 10/872,522

(22) Filed: Jun. 22, 2004

(51) Int. Cl. A61C 5/00

(52) U.S. Cl. 433/215

(57) ABSTRACT

A soft material incisor tooth glove is provided to fit over an upper incisor tooth to prevent a person's upper and lower teeth from contacting each other for temporarily preventing muscle contraction and dental pain.

### BACKGROUND AND SUMMARY OF THE INVENTION

Dental pain can occur when teeth in the upper jaw contact the teeth in the lower jaw, especially when contact is uneven. Every tooth is surrounded by periodontal ligaments which contain nerve proprioceptors. When the teeth in the upper jaw contact the teeth in the lower jaw, these proprioceptors automatically send messages to the brain which in turn sends messages to the masticator muscles of jaws to cause the teeth of the jaws to come together unevenly, which action can cause overloading to some of the temporomandibular joints causing human pain. If a dentist is not at hand, the pain will persist until dental relief can be obtained.

The instant invention relates to a dental appliance which a user can slip over an upper incisor tooth to keep the teeth of the upper jaws improperly contacting the lower jaws and avoiding the aforementioned painful situation. Where only the incisor's contact, only the incisor ligaments are activated and this small contact causes only a few of the teeth proceptors to call for muscle contraction and the pain which can occur thereby. This then provides pain relief to a patient who can get to a dentist for proper treatment.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic showing of the upper front teeth of a human;

FIG. 2 is a schematic of a side view of an upper incisor tooth and its adjacent contact to a lower jaw tooth;

FIG. 3 is a three dimensional showing of an upper incisor tooth glove;

FIG. 4 shows a tooth glove (cut in section) just before it is slipped over the shown upper incisor;

FIG. 5 shows the tooth glove after being slipped over the upper incisor; and

FIG. 6 shows a slipped on tooth glove positioned between an upper incisor and its matching tooth on the lower jaw.

### DETAILED DESCRIPTION OF THE DRAWINGS

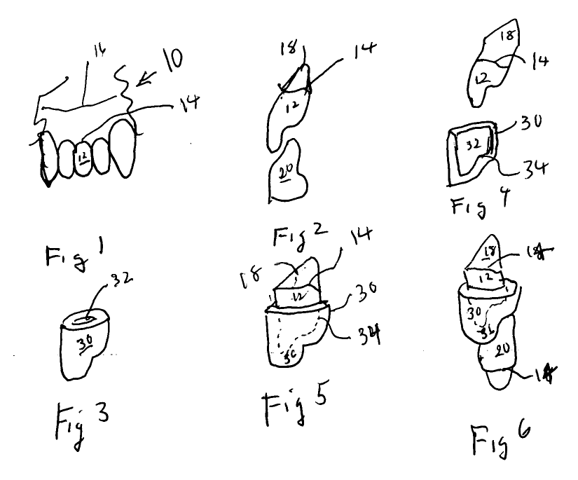

In FIG. 1 a partial upper jaw 10 is shown with a incisor tooth 12, gum line 14 and upper roof 16 of a patient's mouth. FIG. 2 shows a root portion 18 of the incisor 12 above the gum line and a tooth 20 from a patient's lower jaw which normally comes in contact with the upper incisor 12.

FIG. 3 shows an upper incisor tooth glove 30 having an internal hollow 32, which hollow normally conforms to the shape of the upper incisor 12 as shown by the dotted line 34 in FIG. 5 and the full line 34 in FIG. 4.

FIG. 6 shows the glove 30 inserted onto the upper incisor 12 to provide a cushion portion 36 between the upper incisor 12 and its matting tooth 20 in the lower jaw.

The glove 30 is made from a soft flexible plastic or rubber material to provide for a cushion between jaws. Ideally the material allows for cleaning and sterilization.

An advantage can be obtained if the material is elastic. Under such conditions the hollow 32 can be made smaller than most incisor so that the glove 30 can be stretched to be slid over the upper incisor 12 and held thereto by a friction fit. When not stretchable, the hollow needs to be of the same approximate size and shape of the incisors thus necessitating plural sized gloves to handle the population. A persons saliva, internal of the hollow, will cause the non-stretchable glove 30 to be secured to the upper incisor 12 upon insertion.

The walls thickness of the gloves should ideally run between 0.5 cm to 5 cm, the thinner walls making for easier slippage between adjoining teeth.

While the glove 30 is shown with a hollow 32 to fit a single upper incisor tooth 12, the glove could have a larger hollow to cover two adjacent teeth.

Although the present invention has been described and illustrated in detail, it is to be clearly understood that the same is by way of illustration and example only, and is not to be taken by way of limitation. The spirit and scope of the present invention are to be limited only by the terms of the appended claims.

1. A dental muscle relaxer comprising:
a body having a hollow area between a front wall and a rear wall to define a body with a U-shaped cross-section;
the hollow having a dimension between the front and rear walls of a distance approximately equal to a depth of an upper incisor tooth and a height distance less than the height of an upper incisor tooth to permit the hollow to incase an upper incisor tooth to prevent a person's upper and lower teeth from coming in contact.

2. The relaxer of claim 1 wherein the body is made from a stretchable material to allow the body to be stretched to fit over the incisor tooth to frictionally engage the tooth.

3. The relaxer of claim 1 wherein the hollow has sides extending between the front and rear walls so that the hollow has only one opening.

4. The relaxer of claim 2 wherein the hollow has sides extending between the front and rear walls so that the hollow has only one opening.

5. The relaxer of claim 1 wherein the body is made from a soft flexible material.

6. The relaxer of claim 2 wherein the body is made from a soft flexible material.

7. The relaxer of claim 3 wherein the body is made from a soft flexible material.

8. The relaxer of claim 4 wherein the body is made from a soft flexible material.

9. The relaxer of claim 1 wherein the hollow is sized to fit more than a single tooth.

10. The relaxer of claim 2 wherein the hollow is sized to fit more than a single tooth.

11. The relaxer of claim 3 wherein the hollow is sized to fit more than a single tooth.

12. The relaxer of claim 4 wherein the hollow is sized to fit more than a single tooth.

13. The relaxer of claim 5 wherein the hollow is sized to fit more than a single tooth.

14. The relaxer of claim 6 wherein the hollow is sized to fit more than a single tooth.

15. The relaxer of claim 7 wherein the hollow is sized to fit more than a single tooth.

16. The relaxer of claim 8 wherein the hollow is sized to fit more than a single tooth.
